(19) United States
(12) Patent Application Publication
(10) Pub. No.: US 2018/0190246 A1
(43) Pub. Date: Jul. 5, 2018

(54) MULTI-ARM SWIVELING MUTE RACK

(71) Applicant: Steven D. Klein, Monterey Park, CA (US)

(72) Inventor: Steven D. Klein, Monterey Park, CA (US)

(21) Appl. No.: 15/859,918

(22) Filed: Jan. 2, 2018

Related U.S. Application Data
(60) Provisional application No. 62/441,724, filed on Jan. 3, 2017.

(51) Int. Cl. G10D 9/06

(52) U.S. Cl. CPC G10D 9/06

(57) ABSTRACT

A multi-arm swiveling mute rack provides swiveling arms and annular members that retain instrument mutes in an upright position, allowing each mute to be independently swiveled horizontally up to 360° for selective access to mutes. A base portion mounts to a shaft or flat surface near a musician for supporting mute rack. An axle extends vertically from base portion. A stationary lower plate receives axle, and a lower arm terminating at a lower annular member extends from the lower plate to retain a mute. Multiple rotatable upper plates and their respective upper arms terminating at upper annular members stacked above the lower plate. The upper plates swivel about the axle so that their respective arms and annular members swivel while retaining mutes. The arms are marked to define the relative angle of the mutes to each other. Multiple music item containers at the base portion retain music related items.

### CROSS REFERENCE OF RELATED APPLICATIONS

This application claims the benefits of U.S. provisional application No. 62/441,724, filed Jan. 3, 2017 and entitled ROTATABLE INSTRUMENT MUTE HOLDING DEVICE, which provisional application is incorporated by reference herein in its entirety.

### FIELD OF THE INVENTION

The present invention relates generally to a multi-arm swiveling mute rack. More so, a mute rack provides swiveling arms that terminate at annular members sized and dimensioned to retain instrument mutes in an upright position, with the arms allowing each mute to be independently swiveled horizontally up to 360° to a desirable position for facilitated accessibility while a musician is playing a musical instrument; whereby the mute rack comprises a base portion having a base hole that receives a shaft, such as a music stand, for supporting the mute rack, and having an axle extending vertically from the base hole; whereby a stationary lower plate has a lower aperture that enables passage of the axle; whereby a stationary lower annular member extends from the lower plate to receive an instrument mute; whereby a plurality of rotatable upper plates have a plurality of upper apertures that enable passage of the axle; whereby a plurality of rotatable upper annular members extend from the upper plates to receive multiple instrument mutes; whereby the lower and upper plates are arranged in a stacked configuration that enables each upper plate to rotate radially and independently of the other; whereby an adjustment member threadably engages a top end of the axle to enable adjustment of the freedom of rotation by the rotatable upper plates; whereby the upper plates are marked with a marking that indicate relative angular positioning to each other; whereby a first music item container is disposed on the base portion for containing a first item, such as a writing instrument; and whereby a larger second music item container is disposed on the base portion for containing a second item, such as an instrument oil container.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a wind instrument mute is a device used to soften or alter musical sounds from a wind instrument. The mute is often cone shaped, which helps mute the sound from a wind instrument. The mute is often attached to or inserted into a musical instrument to soften or alter its tone The mute may include corks at or near its narrow end to hold the mute in the bell of the cornet, trombone, or other instrument. In many instances, the mute is inserted into the ring portion of conventional mute holders by its narrow end. The wide end of the conic mute rests against the ring, which encircles it. Then when the mute is needed, the mute is lifted entirely out through the ring.

The tone of certain musical instruments, such as the trumpet, trombone and other wind instruments can be modified by the use of a number of differently sized and dimensioned mutes. Thus, it is known in the art to use several mutes during the course of a single session of play, or even a single musical piece. It is frequently the case that a first mute, currently being used, must be rapidly swapped during the course of play for a second mute, which is needed to continue play. In many cases, this swap results in some rapid fumbling around as the musician attempts to remove the first mute and replace the second mute. Further, if the musician is overly hurried, the first mute may not be put into a location where it may be easily reached later. This disorganized assembly of mutes can adversely affect the performance of the musician.

Other proposals have involved devices to retain instrument mutes while the musician is playing the instrument. The problem with these mute retention devices is that they do not horizontally reposition the mutes at a desired position for the musician. Also, they do not provide marking to indicate preset positions for each mute. Even though the above cited mute retention meet some of the needs of the market, a mute rack having a multi-arm swiveling mute rack that provides swiveling arms, terminating at annular members sized and dimensioned to retain multiple instrument mutes in an upright position, and allowing each mute to be independently swiveled horizontally up to 360° to a desirable position for facilitated accessibility while a musician is playing a musical instrument is still desired.

### SUMMARY

Illustrative embodiments of the disclosure are generally directed to a multi-arm swiveling mute rack. The multi-arm swiveling mute rack provides swiveling arms that terminate at annular members sized and dimensioned to retain instrument mutes in an upright position. The arms enable each mute to be independently swiveled up to 360° to a desirable position for facilitated accessibility by a musician during a musical performance.

In some embodiments, the multi-arm swiveling mute rack may include a base portion. The base portion may either mount to a shaft, such as a music stand, or rest on a flat surface near a musician. An axle extends vertically from the base portion, passing through a base hole. A stationary lower plate lies above the base portion. The stationary lower plate receives the axle. A lower arm extends from the stationary lower plate, terminating at a lower annular member. The lower annular member is sized and dimensioned to retain a mute.

A plurality of rotatable upper plates are disposed in a stacked relationship above the lower plate. An upper arm extends from the stationary lower plate, terminating at an upper annular member. The upper annular member is sized and dimensioned to retain a mute. The upper plates swivel about the axle such that their respective arms and annular members rotate independently of each other. The angle position of the arms is marked on the plates to define the relative position of the mutes. This relative positioning of mutes may help in predetermining a desired mute position for each musician. At least one first music item container and a larger second music item container are disposed at the base portion to retain writing instruments, oil containers, mouthpieces, and other music related items.

In one aspect, the multi-arm swiveling mute rack, comprises:
a base portion defined by a bottom surface and a top surface, the base portion forming a centrally disposed base hole;
a threaded axle comprising a top end and a bottom end, the bottom end of the axle at least partially passing through the base hole, the axle comprising clamp threads;
a stationary lower plate defined by a lower aperture, the lower aperture enabling passage of the axle;
a lower arm extending from the stationary lower plate, the lower arm terminating at a lower annular member;
a plurality of rotatable upper plates defined by an upper aperture enabling passage of the axle, the rotatable upper plates disposed in a stacked relationship and rotatable up to 360 degrees about the axle, the rotatable upper plates further defined by a marking, the marking indicating the angular position of each rotatable upper plate relative to the stationary lower plate and the other rotatable upper plates, the marking comprising a molded detent line or an indicia;
an upper arm extending from the rotatable upper plates, the upper arm terminating at an upper annular member;
an adjustment member operatively coupled to the axle and the rotatable upper plates, the adjustment member controlling the freedom of rotation by the rotatable upper plates;
at least one first music item container disposed at the top surface of the base portion, the first music container having a cylindrical shape; and
a second music item container disposed at the top surface of the base portion, the second music container having a cylindrical shape.

In another aspect, the rotatable upper plates comprises four upper plates.

In another aspect, the rotatable upper plates swivel horizontally about the axle.

In another aspect, the rotatable upper plates swivel up to 360°.

In another aspect, the base portion has a generally circular shape.

In another aspect, the axle is threaded.

In another aspect, the axle comprises clamp threads adapted to engage the adjustment member.

In another aspect, the adjustment member is a clamping knob.

In another aspect, the marking is a molded detent line or an indicia.

In another aspect, the at least one first music item container and the second music item container are cylindrical in shape.

In another aspect, the adjustment member accommodates a floor shaft that has a diameter between ½″ to 1″.

One objective of the present invention is to provide a mute rack that can retain multiple mutes in an upright position while offeannular member horizontal swiveling positioning of the mutes for efficient access while playing an instrument.

Another objective is to provide a mute rack that is easily coupled to various sizes and shapes of music stands.

Another objective is to provide adjustment means to fix the annular members in a desired position.

Another objective is to provide a marking on the plates to indicate the relative positioning of the individual annular members.

Another objective is to provide music item containers on the mute rack for containing writing instruments, instrument oil containers, and mouthpieces.

Another objective is to provide a mute rack that can retain multiple wind instrument mutes in an upright position and provide variously sized and shaped annular members for the positioning of the mutes and efficient access while playing a wind instrument.

Another objective is to hold the mutes in an upright position within their respective annular members to enhance drainage and drying of moisture on the mute.

Another objective is to provide a mute rack that is easily coupled to various sizes and shapes of music stands.

Another objective is to provide approximately sized and dimensioned annular members and music item containers for retaining instrument mutes, writing instruments, instrument oil containers, and mouthpieces.

Another objective is to provide a balanced mute rack.

Another objective is to provide an inexpensive to manufacture palette-shaped mute rack.

Another objective is to provide an inexpensive to manufacture mute rack.

Other systems, mute racks, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary multi-arm swiveling mute rack with the annular members in alignment, in accordance with an embodiment of the present invention;

FIG. 2 illustrates a front perspective view of the multi-arm swiveling mute rack shown in FIG. 1 with the annular members radially rotated, in accordance with an embodiment of the present invention;

FIG. 3 illustrates a rear perspective view of the multi-arm swiveling mute rack shown in FIG. 1 with the arms radially swiveled and a shaft passing through the base, the lower plate, and the upper plates, in accordance with an embodiment of the present invention; and

FIG. 4 illustrates a close up view of an exemplary adjustment member regulating the free rotation of upper plates, in accordance with an embodiment of the present invention.

Like reference numerals refer to like parts throughout the various views of the drawings.

### DETAILED DESCRIPTION OF THE INVENTION

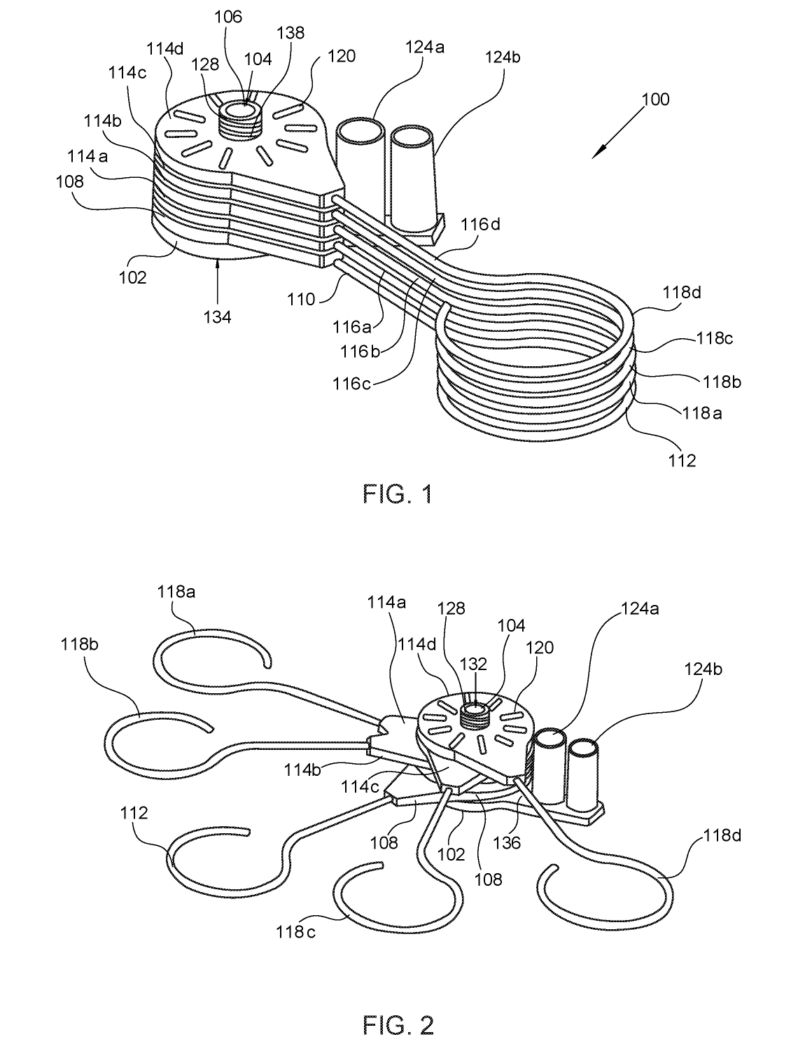

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific mute racks and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention presented in FIGS. 1-4, a multi-arm swiveling mute rack 100, hereafter “mute rack 100”, is configured to provides multiple plates that rotate about an axis, with arms extending from the plates, and the arms terminating at annular members that are configured to receive and retain multiple, variously sized wind instrument mutes (not shown). The swiveling arms allow each mute to be independently swiveled, horizontally up to 360°, to a desirable position for accessibility by a musician during a musical performance. Further, the mute rack 100 provides multiple music item containers that retain items such as, writing instruments, tuning forks, sticks, and reeds in an upright and easy to access position directly in front of the musician.

In some embodiments, the multi-arm swiveling mute rack 100 may include a base portion 102 that may mount to a shaft 200, such as a music stand, or rest on a flat surface near a musician. An axle 104 extends vertically from the base portion 102. A stationary lower plate 108 receives the axle 104, and a lower arm 110, terminating at a lower annular member 112 extend from the lower plate 108. The lower annular member 112 retains a mute. A plurality of rotatable upper plates 114a-d are disposed in a stacked, relationship above the lower plate 108. A plurality of upper arms 116a-d extend from the upper plates 114a-d. The upper plates 114a-d swivel about the axle 104 so that their respective arms and annular members rotate and retain additional mutes. The angle position of the upper arms 116a-d is marked to define the relative position of the mutes. This may help in predetermining a desired mute position for each musician. Further, multiple music item containers 124a-b, 126 are disposed at the base portion 102 retain writing instruments, oil containers, and mouthpieces.

As referenced in FIG. 1, the mute rack 100 comprises a stationary lower plate 108 and a plurality of rotatable upper plates 114a-d that are arranged to form a stacked, spaced-apart relationship. The stationary lower plate 108 is static, remaining fixed to the base portion 102. The upper plates 114a-d swivel up to 360° along a stacked arrangement of planes.

A lower arm 110 extends from the lower plate 108. The lower arm 110 terminates at a lower annular member 112, having a generally ring shape. An upper arm 116a-d extends from the rotatable upper plates 114a-d. The upper arm 116a-d terminates at an upper annular member 118a-d, having a generally ring shape. The annular members 112, 118a-d are sized and dimensioned to receive and retain the instrument mutes in an upright position.

The mute rack 100 is unique in that the relative position of the annular members 112, 118a-d to each other is indicated with a marking 120a-c, such as indicia or T-lines on their respective plates. The marking 120a-c on the rotatable upper plates 114a-d help the musician determine the optimal placement for multiple mutes, based on a musician's needs. The marking 120a-c also assist in positioning of the instrument mutes at desired positions.

For example, the musician can set the position for each upper arm 116a-d at equidistant 20° spacing so that the mutes do not bump into each other as they are being removed and replaced from their respective annular members; thereby allowing for quick access to the mutes is possible during a musical performance. The mute rack 100 also provides multiple music item containers 124a-b, 126 that enable stowage and easy accessibility to instrument related items, such as writing instruments, oil containers, mouthpieces, and the like.

In some embodiments, the instrument for which the mute is used may include, without limitation, a trumpet, cornet, a trombone, a woodwind, and a brass instrument. The mute that is operational with the instrument may include a generally conical-shaped or cone-shaped mute shaped for operation with the trumpet, the cornet, and the trombone. Those skilled in the art will recognize that the mute has a generally, cone shape with a number of corks at or near its narrow end to hold the mute in the bell of the cornet, trombone, or other instrument. The mute is known in the art to rest on a flat surface near the musician, or attach to a music stand, near the musician to enable easy access while the musician plays the instrument.

Those skilled in the art will recognize that a conventional instrument can include an annular member and a clamp member for clamping to a music stand or the like. An instrument mute is typically cone shaped, with a number of corks at or near its narrow end to hold the mute in the bell of the cornet, trombone, or other instrument. In many instances, the mute is inserted into the ring of conventional mute holders by its narrow end. The wide end of the conic mute rests against the annular member, which encircles it. Then when the mute is needed, the mute is lifted entirely out through the annular member.

Unfortunately, there is a tendency for a musician to dislodge the corks against the annular member. After a time, the corks can become loosened and come off the mute. Furthermore, the conventional mute holder clamps do not adapt well to music stands of different thicknesses, nor can they be adjusted to hold the rings firmly at the desired angle that is most convenient for the player. The present adaptation of the mute rack 100 helps resolve these problems by providing multiple, independently swiveling annular members that retain the mutes and can be adjusted to lock into place or rotate up to 360° for convenient access to the musician.

As referenced in FIG. 2, the mute rack 100 comprises a base portion 102 defined by a top surface 136, a bottom surface 134, and a base hole 132. In one embodiment, the base portion 102 is generally flat and has a circular shape. Though in other embodiments, the base portion 102 may have an oval shape, a rectangular shape, a triangular shape, and a square shape. The base hole 132 is centrally disposed through the base portion 102.

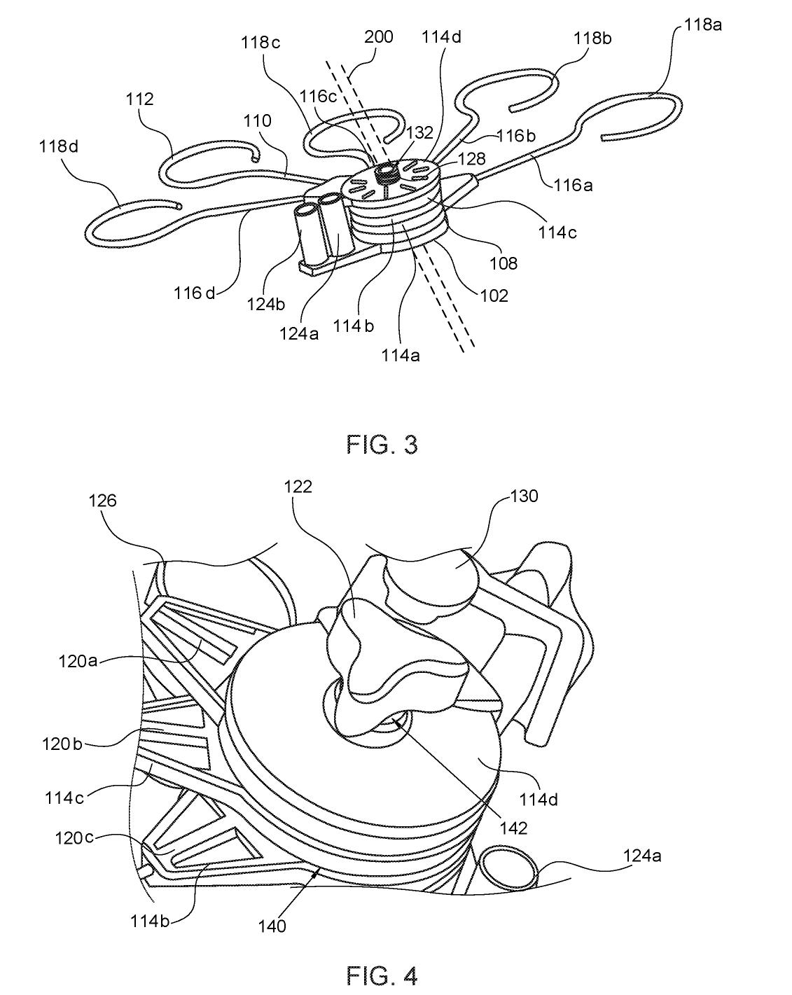

As FIG. 3 illustrates, the base hole 132 is sized and dimensioned to concentrically receive a shaft 200, such as a music stand, that passes through the base hole 136. In this manner, the shaft 200 supports the mute rack 100 and the mutes in an upright position. The shaft 200 and base hole 136 may engage in a friction fit relationship; or in other embodiments, a screw or other fastening mechanism may be used to press the base portion 102 against the shaft 200. The shaft 200 may include a music stand used to hold musical sheets and music related items. Though any supportive surface or elongated member near a musician may be used. In this manner, the mute rack 100 may detachably couple to either a flat surface, or to variously sized and dimensioned music stands.

Further, an axle 104 passes through the base hole 136 to enable the various rotatable upper plates 114a-d to rotate thereabout. The axle 104 also provides the elongated surface that holds the plates 108, 114a-d and annular members together. The axle 104 extends vertically from the base hole 136 of the base portion 102. The axle 104 is defined by a top end 106 and a bottom end 138. The axle 104 also serves to enable rotation of the upper plates 114a-d. In one embodiment, the axle 104 is threaded. In another embodiment, a clamp thread 128 may wind around the axle 104 to provide tension to the swiveling arms 110, 116a-d. The threaded configuration enables adjustable manipulation of the freedom of swiveling articulation by the upper plates 114a-d, as described below.

Looking now at FIG. 3, a stationary lower plate 108 fixedly positions on the top surface 136 of the base portion 102. The stationary lower plate 108 has a lower aperture 140 that enables passage of the axle 104. Thus, the axle 104 passes concentrically through the base portion 102 and the stationary lower plate 108. In this manner, the axle 104 passes through the lower aperture 140 of the stationary lower plate 108. The axle 104 may be hollow to enable the shaft 200, or music stand to pass through. Thus, shaft 200, such as a music stand, passes through the base hole 132 and the axle 104 to mount the mute rack 100.

Furthermore, the lower aperture 140 is configured to inhibit a rotational relationship with the axle 104. Thus, the stationary lower plate 108 remains fixed at a fixed starting position. Though, by rotating the base portion 102 relative to the musician, the stationary lower plate 108 can be made to face in any direction up to 360°.

In some embodiments, a lower arm 110, which terminates at a lower annular member 112, extends from the stationary lower plate 108. The lower annular member 112 has a circumference sufficient to receive an instrument mute. In one embodiment, the lower annular member 112 has a diameter between 8-30 millimeters. Thus, while the lower annular member 112 receives the instrument mute, the lower annular member 112 cannot rotate freely about the axle 104 because the stationary lower plate 108 is fixed to the base portion 102. In this manner, the mute remains fixed at a set angle position. For the lower plate to rotate, the entire base portion 102 would require rotation, so as to adjust the angular position of the lower annular member 112.

In some embodiments, the mute rack 100 may also include a plurality of rotatable upper plates 114a-d that forms a spaced-apart, stacked relationship with each other and the stationary lower plate 108. The rotatable upper plates 114a-d are defined by concentrically disposed plurality of upper apertures 142. The upper apertures 142 enable passage of the axle 104. In one embodiment, the upper apertures 142 are configured to receive the top end 106 of the axle 104, and thereby enable rotation by the rotatable upper plates 114a-d about the axle 104.

The rotatable upper plates 114a-d rotate horizontally about the axle 104. Further, the axle 104 may be hollow, so as to enable the shaft 200, or music stand, to pass through. Thus, shaft 200, such as a music stand, passes through the base hole 132 of the base portion 102, and the axle 104, so as to mount the mute rack 100.

As illustrated in the close up view of FIG. 4, the rotatable upper plates 114a-d comprises a marking 120a, 120b, 120c that indicates the relative angular position of the upper plates 114a-d to each other, and also to the stationary lower plate 108. The marking 120a-c may include a molded detent T-shaped line, or an indicia. The markings 120a, 120b, 120c provide a quick visual aid in positioning the upper annular members 118a-d and their respective mutes, as described below.

However in other embodiments, the marking 120a-c may include movable dials, compasses, and other indicia known in the art. The marking 120a-c on each rotatable upper plate 114a-d can be compared in relation to each other to determine the angle of the upper plates 114a-d. Also, by recalling the position of the marking 120a-c, a specific positioning of upper plates 114a-d may be used multiple times based on the predetermined positioning of the markings 120a-c.

In some embodiments, the mute rack 100 may further include plurality of upper arms 116a-d. The upper arms 116a-d extend from the upper plates 114a-d. The upper arms 116a-d extend longitudinally, terminating at a plurality of upper annular members 118a-d. The upper arms 116a-d may be used to extend the upper annular members 118a-d from the rotatable upper plates 114a-d to a predetermined distance. In one embodiment, both the upper and lower arms 116a-d, 110 are length adjustable. In some embodiments, the upper and lower arms 116a-d, 110 are rigid wires.

The upper annular members 118a-d are sized and dimensioned to receive multiple instrument mutes. In one embodiment, shown in FIG. 1, the upper annular members 118a-d have an open-ring shape. As discussed above, the rotatable upper plates 114a-d swivel horizontally about the axle 104. This creates a radial, fanning out of the upper annular members 118a-d and their respective mutes retained therein. However, the lower annular member 112 remains stationary.

In one embodiment, the upper annular member 118a-d has a diameter between 8-30 millimeters, so as to securely retain the generally bell-shaped instrument mutes. In one embodiment, four rotatable upper annular members 118a, 118b, 118c, 118d are used. Though in other embodiments, more than four or less than four upper annular members 118a-d may be used. The upper annular members 118a-d may be closed, or may leave a space for fitting the mute within the circumference of the annular members 118a-d.

The stationary lower plate 108 and the rotatable upper plates 114a-d are arranged in a stacked configuration that enables each upper plate 114a to rotate radially and independently of the other plates 114b-d. Though the lower plate 108 and attached lower annular member 112 remain substantially stationary. In this manner, the upper annular members 118a-d may radially fan out and each upper annular member 118a-d and the lower annular member 112 can be spaced apart from the other to enable multiple instrument mutes to be retained simultaneously.

Looking again at FIG. 4, the mute rack 100 also provides an adjustment member 122 that regulates the freedom of rotation by the rotatable upper annular members 118a-d. The adjustment member 122 is useful for accommodating both a ½″ and a 1″ diameter shaft, such as a music stand. Furthermore, the adjustment member 122 is configured to couple to the axle 104 and the plurality of rotatable upper plates 114a-d.

Thus, when rotated in a first direction, the adjustment member 122 works by applying a frictional force against the axle, or the sides of the upper plates 114a-d, or the shaft, i.e., music shaft, so as to restrict swiveling articulation of the upper plates 114a-d. When rotated in a second direction, the adjustment member 122 works by removing a frictional force against the axle, or the sides of the upper plates 114a-d, or the shaft, i.e., music shaft, so as to enable free swiveling articulation by the upper plates 114a-d.

In one non-limiting embodiment, the adjustment member 122 may operate by increasing and decreasing the friction coefficient between the upper apertures of the upper plates 114a-d and the axle 104. In this manner, the upper plates 114a-d can be fully restricted from rotating, or released for rotating freely. The upper annular members 118a-d are free to swing horizontally, except when restricted by the adjustment member 122.

In another embodiment, the adjustment member 122 is a clamping knob that engages and disengages the axle 104 to increase or reduce the friction coefficient between the axle 104 and the upper apertures of the rotatable upper plates 114a-d. In one embodiment, a clamp thread 128 may wind around the axle 104. The adjustment member 122 may threadably engage the clamp thread 128 that winds around the top end 106 of the axle 104. This adjustable contraction and release with the clamp thread 128 enables adjustment of the freedom of rotation by the rotatable upper plates 114a-d.

In some embodiments, the adjustment member 122 accommodates a shaft 200 having a diameter of ½″ or 1″. In one embodiment, a lock switch 130 is operable with the adjustment member 122 to lock the setting of the adjustment member 122. The lock switch 130 is selectively displaced to serve as a barrier to the adjustment member 122.

Turning back to FIG. 1, the mute rack 100 provides at least one first music item container 124a, 124b that is disposed on the base portion 102, or slightly extending from the base portion 102. The first music item container 124a-b may include a generally cylindrical container that is sized and dimensioned to contain a first item, such as a writing instrument that is pertinent to music.

In one embodiment, two first music item containers 124a-b are used. In another embodiment, the mute rack may also include a second music item container 126. The second music item container 126 is also disposed on the base portion 102, but opposite the first music item container 124a, 124b (FIG. 4). The second music item container 126 may be larger than the first music item container 124a, 124b, and therefore used for containing a second larger item, such as an instrument oil container or a mouthpiece. However, in some embodiments, either the first or second music item container 124a, 124b, 126 may not be used; or a greater number of music item containers 124a, 124b, 126 may be used.

In operation, the musician removes the musical instrument and the mute rack 100 from an instrument case. The music stand is positioned adjacent to the musician in preparation for playing the instrument. The adjustment member 122 on the mute rack 100 is loosened to enable coupling with the shaft on the music stand. The adjustment member 122 can be adjusted to accommodate ½″ or 1″ diameter shafts. The shaft passes through the base hole 132. As discussed above, the base hole 132 is sized and dimensioned to receive a shaft, such as a music stand that passes through the base hole 136 concentrically.

Initially, the annular members 112, 118a-d are aligned atop each other. The mute can be placed into the uppermost annular member 118d. However, if the user wishes to use multiple mutes, the annular members 118a-c can be rotated horizontally to achieve a desired position for retaining the mutes. For example, a first mute retained in the lower annular member 112 is positioned directly in front of the musician, while a second mute retained in one of the upper annular members 118a is rotated to the left of the musician.

In this manner, the musician then has easy access to both mutes simultaneously. When the musician has completed playing the instrument, the top annular members 118a-d are rotated into alignment with the lower annular member 112, the adjustment member 122 loosened, and the mute rack 100 detached from the music stand shaft for stowage into the instrument case.

In conclusion, a multi-arm swiveling mute rack 100 provides swiveling arms and annular members that retain instrument mutes in an upright position, allowing each mute to be independently swiveled horizontally up to 360° for selective access to mutes. A base portion 102 mounts to a shaft or flat surface near a musician for supporting mute rack 100. An axle 104 extends vertically from base portion 102. A stationary lower plate 108 receives the axle 104, and a lower arm, terminating at a lower annular member extends from the lower plate 108 to retain a mute. Multiple rotatable upper plates 114a-d and their respective upper arms, terminating at upper annular members are stacked above the lower plate. The upper plates 114a-d swivel about the axle so that their respective arms and annular members swivel while retaining mutes. The arms are marked to define the relative angle of the mutes to each other. Multiple music item containers 124a, 124b, 126 at the base portion 102, and directly in front of the musician, retain music related items.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A multi-arm swiveling mute rack, the mute rack comprising:
a base portion defined by a bottom surface and a top surface, the base portion forming a centrally disposed base hole;
an axle comprising a top end and a bottom end, the bottom end of the axle at least partially passing through the base hole;
a stationary lower plate defined by a lower aperture, the lower aperture enabling passage of the axle;
a lower arm extending from the stationary lower plate, the lower arm terminating at a lower annular member;
a plurality of rotatable upper plates defined by an upper aperture enabling passage of the axle, the rotatable upper plates disposed in a stacked relationship and rotatable about the axle, the rotatable upper plates further defined by a marking, the marking indicating the angular position of each rotatable upper plate relative to the stationary lower plate and the other rotatable upper plates;
an upper arm extending from the rotatable upper plates, the upper arm terminating at an upper annular member;
an adjustment member operatively coupled to the axle and the rotatable upper plates, the adjustment member controlling the freedom of rotation by the rotatable upper plates; and
at least one first music item container disposed at the top surface of the base portion.

2. The mute rack of claim 1, further comprising a second music item container disposed at the top surface of the base portion.

3. The mute rack of claim 1, wherein the rotatable upper plates comprises four upper plates.

4. The mute rack of claim 1, wherein the rotatable upper plates swivel horizontally about the axle.

5. The mute rack of claim 1, wherein the rotatable upper plates swivel up to 360 degrees.

6. The mute rack of claim 1, wherein the base portion has a generally circular shape.

7. The mute rack of claim 1, wherein the axle is threaded.

8. The mute rack of claim 1, wherein the axle comprises clamp threads adapted to engage the adjustment member.

9. The mute rack of claim 1, wherein the adjustment member is a clamping knob.

10. The mute rack of claim 1, wherein the marking is a molded detent line or an indicia.

11. The mute rack of claim 1, wherein the at least one first music item container and the second music item container are cylindrical in shape.

12. The mute rack of claim 1, wherein the adjustment member accommodates a shaft having a diameter between ½ inch to 1 inch.

13. A multi-arm swiveling mute rack, the mute rack comprising:
a base portion defined by a bottom surface and a top surface, the base portion forming a centrally disposed base hole;
a threaded axle comprising a top end and a bottom end, the bottom end of the axle at least partially passing through the base hole;
a stationary lower plate defined by a lower aperture, the lower aperture enabling passage of the axle;
a lower arm extending from the stationary lower plate, the lower arm terminating at a lower annular member;
a plurality of rotatable upper plates defined by an upper aperture enabling passage of the axle, the rotatable upper plates disposed in a stacked relationship and rotatable about the axle, the rotatable upper plates further defined by a marking, the marking indicating the angular position of each rotatable upper plate relative to the stationary lower plate and the other rotatable upper plates;
an upper arm extending from the rotatable upper plates, the upper arm terminating at an upper annular member;
an adjustment member operatively coupled to the axle and the rotatable upper plates, the adjustment member controlling the freedom of rotation by the rotatable upper plates;
at least one first music item container disposed at the top surface of the base portion; and
a second music item container disposed at the top surface of the base portion.

14. The mute rack of claim 13, wherein the rotatable upper plates comprises four upper plates.

15. The mute rack of claim 13, wherein the rotatable upper plates swivel up to 360 degrees.

16. The mute rack of claim 13, wherein the base portion has a generally circular shape.

17. The mute rack of claim 13, wherein the axle comprises clamp threads adapted to engage the adjustment member.

18. The mute rack of claim 13, wherein the adjustment member is a clamping knob.

19. The mute rack of claim 13, wherein the marking is a molded detent line or an indicia.

20. A multi-arm swiveling mute rack, the mute rack consisting of:
a base portion defined by a bottom surface and a top surface, the base portion forming a centrally disposed base hole;
a threaded axle comprising a top end and a bottom end, the bottom end of the axle at least partially passing through the base hole, the axle comprising clamp threads;
a stationary lower plate defined by a lower aperture, the lower aperture enabling passage of the axle;
a lower arm extending from the stationary lower plate, the lower arm terminating at a lower annular member;
at least four rotatable upper plates defined by an upper aperture enabling passage of the axle, the rotatable upper plates disposed in a stacked relationship and rotatable up to 360 degrees about the axle, the rotatable upper plates further defined by a marking, the marking indicating the angular position of each rotatable upper plate relative to the stationary lower plate and the other rotatable upper plates, the marking comprising a molded detent line or an indicia;
an upper arm extending from the rotatable upper plates, the upper arm terminating at an upper annular member;
an adjustment member operatively coupled to the axle and the rotatable upper plates, the adjustment member controlling the freedom of rotation by the rotatable upper plates;
at least one first music item container disposed at the top surface of the base portion, the at least one first music item container defined by a generally cylindrical shape; and
a second music item container disposed at the top surface of the base portion, the second music item container defined by a generally cylindrical shape.
